(19) United States
(12) Patent Application Publication
(10) Pub. No.: US 2017/0026653 A1
(43) Pub. Date: Jan. 26, 2017

(54) METHOD FOR SCALABLE TRANSMISSION OF VIDEO TRACT

(71) Applicants: Shengli Xie, Guangzhou City (CN); Zongze Wu, Guangzhou City (CN); Kan Xie, Guangzhou City (CN); Haochuan Zhang, Guangzhou City (CN)

(72) Inventors: Shengli Xie, Guangzhou City (CN); Zongze Wu, Guangzhou City (CN); Kan Xie, Guangzhou City (CN); Haochuan Zhang, Guangzhou City (CN)

(21) Appl. No.: 14/805,280

(22) Filed: Jul. 21, 2015

(51) Int. Cl. H04N 19/187; H04N 19/30; H04N 19/423; H04N 19/176

(52) U.S. Cl. CPC H04N 19/187; H04N 19/176; H04N 19/30; H04N 19/423

(57) ABSTRACT

The present disclosure provides a method for scalable transmission of a video track. In the method, a video source is compressed and encoded by using a scalable video coding scheme and information related to the encoding process is recorded. A video track file is generated for describing importance and address information for the respective code stream block. During the video transmission process, a code stream selection unit selects and organizes a code stream based on the video track file and an available network bandwidth for transmission. A video receiver receives and decodes the code stream and estimates the available network bandwidth and feeds information on the available network bandwidth back to the video transmitter. With the method according to the present disclosure, the smoothness of the video can be guaranteed even if the network environment deteriorates, despite some degradation in video quality.

### TECHNICAL FIELD

The present disclosure relates to video track transmission, and more particularly, to a method for scalable transmission of a video track in association with a video track file and an available network bandwidth.

### BACKGROUND

Conventionally, a source is encoded once at a video encoder and then decoded at all terminals in the same way to obtain videos with the same reproduction quality. In this case, network bandwidth resources are restricted. However, the core concept of the network transmission oriented scalable video coding technique, which has a broad application prospect, is to divide video signal coding into several layers, so as to be scalable and adaptive to bandwidth. With the development of network communication technologies, especially the broadband network, it is desired that the video coding can be adapted to different channel transmission rates. The encoding output of hierarchical coding can be divided into a base layer code stream and an enhancement layer code stream, which can be flexibly selected based on the transmission channel and the capability of the video receiving device to achieve an optimal video display. The scalability of the scalable video coding mainly includes temporal scalability, spatial scalability and quality scalability.

The quality scalability of the scalable video coding refers to the scalability of PSNR, i.e., layered encoding and transmission based on video quality. Generally, its role in the entire coding system is to select an appropriate scheme in cooperation with a spatial processing scheme. It is applied subsequent to the spatial processing to remove redundancies and improve compression efficiency. Generally, all entropy coding schemes belong to this category. In view of the wide application of wavelet transform, the processing technique associated with the quality scalability will be discussed here based on the coding architecture of wavelet transform. As the wavelet theory evolves, there have been more and more schemes for wavelet coefficient coding. One of the most classic algorithms is Shapiro's Embedded Zerotree Wavelet (EZW) algorithm. After that, in order to improve the EZW algorithm, many new algorithms having better performances have been proposed, e.g., multi-layered tree set splitting, set splitting embedded block coding, reversible embedded wavelet compression, embedded zero tree wavelet coding, and motion-based embedded sub-band optimal truncation coding. Typically, the quality scalable coding can be achieved by directly applying hierarchical quantization to DCT coefficients and applying the FGS concept.

In a multi-media system adopting the scalable video coding scheme, video code streams to be transmitted vary depending on application scenarios. There is thus a need for a solution for code stream selection. The present disclosure is made based on conventional video track files and is directed to solving the technical problem associated with code stream selection.

### SUMMARY

It is an object of the present disclosure to overcome the above defect in the conventional schemes by providing a method for scalable transmission of a video track, such that a transmission rate of the video can be flexibly adapted to an available network bandwidth. When the available network bandwidth is insufficient (or when a terminal has a low requirement), the transmission rate of the video data can be relatively low, resulting in a low video quality. On the other hand, when the available network bandwidth become higher (or when a terminal has a higher requirement), the transmission rate of the video data can be higher, resulting in an improved video quality. The above object is achieved by the following embodiments.

According to an embodiment, a method for scalable transmission of a video track is provided. The method comprises: generating a video track file; detecting, at a video receiver, an available network bandwidth passively; and selecting, at a video transmitter, a video code stream based on address information of code stream blocks described in the video track file and the available network bandwidth for transmission.

In the above method, the step of generating of the video track file comprises: 1) reading, by an encoder, a predetermined number of frames from a video source to constitute a video group; 2) applying a scalable video encoding to generate a code stream block that can be truncated arbitrarily; and 3) calculating a distortion caused by loss of a particular code stream block.

In the above method, the video data is transmitted in units of video groups, the available network bandwidth is detected at the video receiver by measuring a time period required for receiving one video group and a total amount of data in one video group, a total amount of data in the video group requested by the video receiver for transmission is calculated further based on a frame rate for video play. When the currently detected available network bandwidth is not suitable for transmitting high quality video, at least one code stream block having a low importance parameter is discarded in a next video group. When the currently detected available network bandwidth is capable of transmitting higher quality video, at least one code stream block having a low importance parameter is added to a next video group to be transmitted.

In the above method, the transmitted video comprises at least base code stream blocks, the total amount of data in the transmitted video group is dependent on the current available network bandwidth and determines code stream blocks having which importance parameter are included in the video group, the available network bandwidth is measured based on the total amount of data in the video group and determines the total amount of data in the next video group.

In the above method, the video track file has a description element that is a information set, layer_information, associated with the code stream block, the information set, layer_information, comprises: a time dimension index, T_index, a space dimension index, L_index, a quality dimension index, Q_index, an index of the code stream block in a frame, layer_index, a distortion caused by loss of the code stream block, layer_distortion, an amount of data in the code stream block, layer_length, an importance parameter for the code stream block, layer_important, and a total amount of data in an important code stream block, data_important. The distortion caused by loss of the code stream block, layer_distortion, is calculated as:

$${layer}_{—} distortion = {\sum }_{0 < i \leq g} ( {\sum }_{0 < j \leq h} ( {\sum }_{0 < k \leq w} ( {a}_{ijk} - {a}_{ijk}^{′} ) ) )$$

where g is a predetermined number of frames included in one video group, g=16; H is a height of one frame in a DCT transform domain; W is a width of one frame in the DCT transform domain: aᵢⱼₖ is a coefficient at a height of j and a width of k in the i-th frame when the code stream block is retained; and a′ᵢⱼₖ is a coefficient at a height of j and a width of k in the i-th frame when the code stream block is discarded.

In the above method, the video data in the DCT transform domain is quantized, then the quantized code stream block is entropy encoded, and the amount of data in the code stream block, layer_length, is recorded. The importance parameter for the code stream block, layer_important, is calculated based on the distortion caused by loss of a particular code stream block, layer_distortion, and the amount of data in the code stream block, layer_length:

$${layer}_{—} {improtant}_{i} = \frac{{layer}_{—} {distortion}_{i}}{{layer}_{—} {length}_{i}}$$

where layer_distortion; is the distortion caused by loss of the i-th code stream block in the video group, layer_length; is the amount of data in the i-th code stream block.

In the above method, the information sets for the code stream blocks, layer_information, are sorted based on the importance parameters for the code stream blocks, layer_important, and an index of each layer_information is identified, the total amount of data in the important code stream block, data_important, is counted in the video group, which is a sum of the amount of data in a particular code stream block and the amount of data in the code stream blocks each having a higher importance parameter than that code stream block in the video group:

$${data}_{—} {important}_{j} = {\sum }_{1 \leq k \leq j} {layer}_{—} {length}_{k}$$

where j and k denote the indices of the respective layer_information after the information sets for the code stream blocks, layer_information, have been sorted.

In the above method, the available network bandwidth is detected at the video receiver by measuring a time period required for receiving one video group and a total amount of data in one video group, a total amount of data in the video group requested for transmission, data_request, is calculated at the video receiver by rounding a product of the available network bandwidth, band_width, and a frame frequency at the video receiver, time_group:

data_request=[band_width*time_group].

In the above method, the total amount of data in the important code stream block, data_important, is determined at the video receiver based on the total amount of data in the video group requested by the video receiver for transmission, data_request:

$${data}_{—} {important}_{x} = \{ \begin{matrix}{data}_{—} {important}_{{i}_{—} first} , ( {data}_{—} request < {data}_{—} {important}_{{i}_{—} first} ) \\ {data}_{—} {important}_{i} , ( \begin{matrix}{data}_{—} {important}_{i - 1} < {data}_{—} request \leq {data}_{—} {important}_{i} , \\ {data}_{—} {important}_{0} = 0 , \\ {i}_{—} first \leq i \leq {i}_{—} last \end{matrix} ) \\ {data}_{—} {important}_{{i}_{—} last} , ( {data}_{—} request > {data}_{—} {important}_{{i}_{—} last} ) \end{matrix}$$

where x is an index of layer_information where the total amount of data in the important code stream block, data_important, is found; i_first is an index of layer_information for the most important code stream block and here i_first=1; i_last is an index of layer_information for the least importance code stream block and here i_last=64; data_important₀ is a variable set to search for data_important and here data_important₀=0; data_importantᵢ_{_}_{first} is data_important associated with the most important code stream block and here data_importantᵢ_{_}_{first}=data_important₁=layer_length₁; and data_importantᵢ_{_}ₗₐₛₜ is data_important associated with the least important code stream block.

In the above method, data_importantₓ reflects the total amount of data in the transmitted video group, data_send=data_importantₓ.

In the above method, the address information of the code stream blocks is determined at the video transmitter by analyzing layer_information having indices smaller than or equal to x among the layer_information associated with the code stream blocks in the video group, so as to organize the transmission of the video code stream; the video code stream is received at the video receiver when the video transmitter transmits the code stream; the address information of each code stream block comprises a time dimension index, T_index, a space dimension index, L_index, a quality dimension index, Q_index, a unique index of the code stream block in a frame, layer_index.

In the above method, the information sets, layer_information, for the code stream blocks in one video group are sorted based on the importance for each code stream block, layer_important, and an index of each layer_information is identified. The layer_information having a larger layer_important is prioritized over the layer_information having a smaller layer_important, such that the more important code stream block will have a higher priority for transmission over the network.

The present disclosure provides the following advantages and effects over the conventional schemes. In the present disclosure, the video data is transmitted in units of video groups. The video transmission can be adapted to the available network bandwidth. Thus, the present disclosure involves measurement of the available network bandwidth. The video receivers estimates the available network bandwidth by measuring a time period required for receiving one video group and a total amount of data in one video group and calculates a total amount of data in the video group requested by the video receiver for transmission further based on a frame rate for video play. When the currently detected available network bandwidth is not suitable for transmitting high quality video, at least one code stream block having a low importance parameter is discarded in a next video group. When the currently detected available network bandwidth is capable of transmitting higher quality video, at least one code stream block having a low importance parameter is added to a next video group to be transmitted. In either case, the transmitted video comprises at least base code stream blocks. The total amount of data in the transmitted video group is dependent on the current available network bandwidth and determines code stream blocks having which importance parameter are included in the video group. The available network bandwidth is measured based on the total amount of data in the video group and determines the total amount of data in the next video group. That is, the video transmission can be adapted to the available network bandwidth. In this way, the smoothness of the video can be guaranteed even if the network environment deteriorates, despite some degradation in video quality.

### BRIEF DESCRIPTION OF THE DRAWINGS

FIG. 1 shows generation of a video track file;

FIG. 2 shows estimation of an available network bandwidth; and

FIG. 3 shows a transmission system organizing a transmission code stream based on the video track file and the available network bandwidth.

### DETAILED DESCRIPTION OF THE EMBODIMENTS

The embodiments of the present disclosure will be further detailed with reference to the figures which facilitate understanding of the embodiments of the present disclosure by explaining the principals and implementations of the present disclosure in conjunction with the description, rather than limiting the scope of the present disclosure.

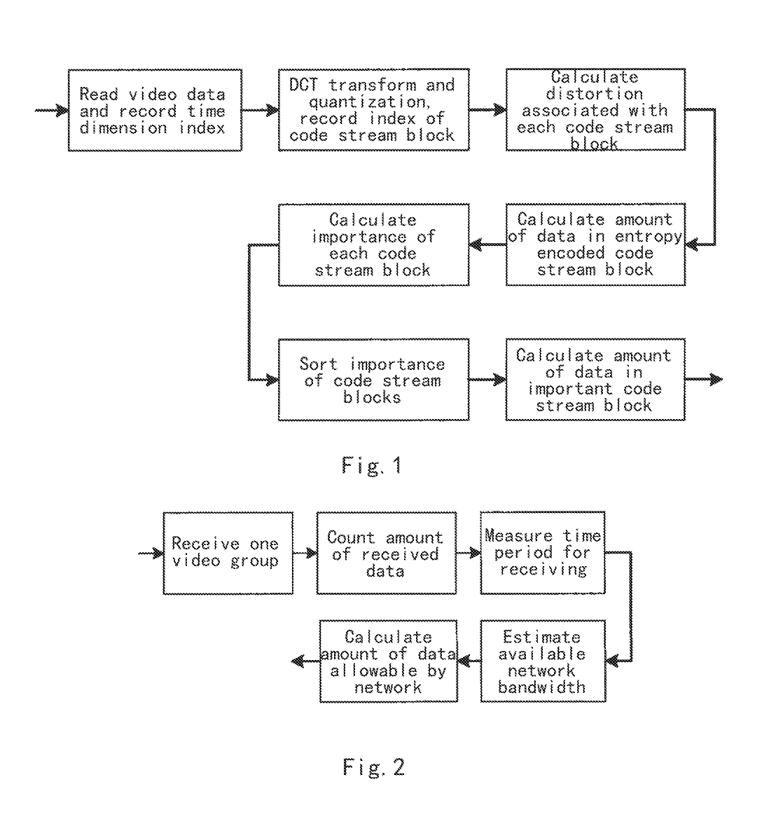

An important aspect of this embodiment is generation of a video track file. The video track file can be generated during a scalable video coding process. The steps of generation are shown in FIG. 1.

1) An encoder first reads 16 frames from a video source to constitute a video group.

2) A scalable video encoding process is applied to generate a code stream block that can be truncated arbitrarily.

3) A distortion caused by loss of a particular code stream block is calculated. The distortion of the video data in a DCT transform domain is represented as layer_distortion. The distortion caused by loss of a particular code stream block is a sum of distortions of all coefficients in the video group and can be calculated as:

$${layer}_{—} distortion = {\sum }_{0 < i \leq g} ( {\sum }_{0 < j \leq h} ( {\sum }_{0 < k \leq w} ( {a}_{ijk} - {a}_{ijk}^{′} ) ) )$$

where g is the number of frames included in one video group, in this case g=16;

H is a height of one frame in the DCT transform domain;

W is a width of one frame in the DCT transform domain;

aᵢⱼₖ is a coefficient at a height of j and a width of k in the i-th frame when the code stream block is retained; and

a′ᵢⱼₖ is a coefficient at a height of j and a width of k in the i-th frame when the code stream block is discarded.

4) The video data in the DCT transform domain is quantized, and then the quantized code stream block is entropy encoded. A Context-based Adaptive Variable Length Coding (CAVLC) is adopted here, which takes full advantage of the characteristics of the transformed and quantized residual data in compression to further reduce redundant information in the data. After the entropy encoding, the amount of data in each code stream block, layer_length, is recorded.

5) An importance parameter for the code stream block, layer_important, is calculated as:

$${layer}_{—} {improtant}_{i} = \frac{{layer}_{—} {distortion}_{i}}{{layer}_{—} {length}_{i}}$$

where layer_distortionᵢ is the distortion caused by loss of the i-th code stream block in the video group, and layer_length; is the amount of data in the i-th code stream block.

Layer_important represents the distortion of the code stream block over a data amount unit. When the amount of data in the code stream block, layer_length, is constant, the higher the distortion caused by loss of a particular code stream block, layer_distortion, the larger the value of layer_important and accordingly the more important the code stream block; whereas the lower the layer_distortion, the smaller the value of layer_important and accordingly the less important the code stream block. When the distortion caused by loss of a particular code stream block, layer_distortion, is constant, the larger the amount of data in the code stream block, layer_length, the smaller the value of layer_important and accordingly the less important the code stream block; whereas the smaller the layer_length, the larger the value of layer_important and accordingly the more important the code stream block.

Then, the information sets, layer_information, for the code stream blocks in the video group are sorted based on the importance parameters for the code stream blocks, layer_important. Layer_information containing a larger value of layer_important has a smaller index and the associated code stream block has a higher priority for transmission. Layer_information containing a smaller value of layer_important has a larger index and the associated code stream block has a lower priority for transmission.

6) A total amount of data in the important code stream block, data_important, is calculated. Data_important is a sum of the amount of data in a particular code stream block and the amount of data in the code stream blocks each having a higher importance parameter than that code stream block in the video group. Data_important is calculated as:

$${data}_{—} {important}_{j} = {\sum }_{1 \leq k \leq j} {layer}_{—} {length}_{k}$$

where j and k denote the indices of the respective layer_information after the information sets for the code stream blocks, layer_information, have been sorted. Data_important corresponds to the total amount of data in the video group transmitted over the network.

FIG. 2 shows a process for estimating the available network bandwidth, which includes the following steps.

(1) The video receiver continuously receives code stream blocks included in one video group.

(2) While receiving the video code stream, the video receiver counts the total amount of data in one video group, data_receive, with a counter.

(3) While receiving the video code stream, the video receiver measures the time period for receiving one video group, time_receive, with a timer.

(4) The available network bandwidth, band_width, can be calculated by dividing the total amount of data in the received video group by the time period consumed, as:

$${band}_{—} width = \frac{{data}_{—} receive}{{time}_{—} receive} .$$

(5) The total amount of data in the video group requested for transmission, data_request, is calculated at the video receiver by rounding a product of band_width and time_group, as:

data_request=[band_width*time_group].

Finally, the video receiver feeds a message containing data_request back to the video transmitter.

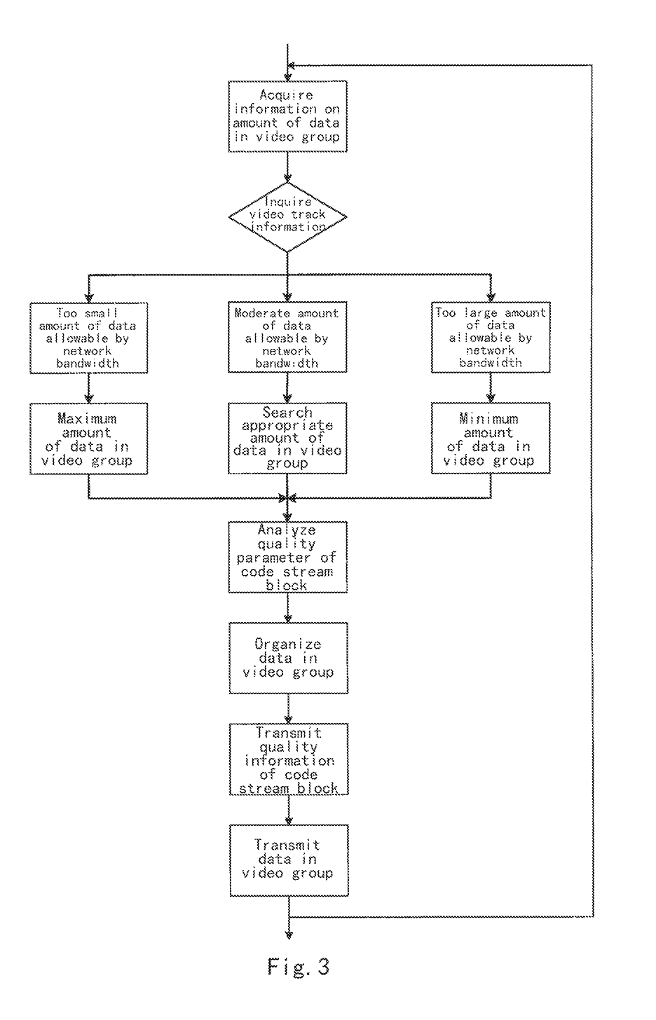

Another important aspect of the method is to organize video data for transmission based on the video track file and the available network bandwidth. FIG. 3 shows main steps for a transmission system to organize a code stream.

The video transmitter records the total amount of data in the video group requested by the video receiver for transmission, data_request, and searches the information set, layer_information, for the code stream block for data_important, subjected to the constraint of data_request, as follows:

$${data}_{—} {important}_{x} = \{ \begin{matrix}{data}_{—} {important}_{{i}_{—} first} , ( {data}_{—} request < {data}_{—} {important}_{{i}_{—} first} ) \\ {data}_{—} {important}_{i} , ( \begin{matrix}{data}_{—} {important}_{i - 1} < {data}_{—} request \leq {data}_{—} {important}_{i} , \\ {data}_{—} {important}_{0} = 0 , \\ {i}_{—} first \leq i \leq {i}_{—} last \end{matrix} ) \\ {data}_{—} {important}_{{i}_{—} last} , ( {data}_{—} request > {data}_{—} {important}_{{i}_{—} last} ) \end{matrix}$$

where x is an index of layer_information where the total amount of data in the important code stream block, data_important, is found; i_first is an index of layer_information for the most important code stream block and here i_first=1; i_last is an index of layer_information for the least importance code stream block and here i_last=64; data_important₀ is a variable set to search for data_important and here data_important₀=0; data_importantᵢ_{_}_{first} is data_important associated with the most important code stream block and here data_importantᵢ_{_}_{first}=data_important₁=layer_length₁; and data_importantᵢ_{_}ₗₐₛₜ is data_important associated with the least important code stream block.

In a first case, the amount of data allowable by the available network bandwidth is so small that the minimum value of data_important does not meet the constraint that data_important shall be smaller than or equal to data_request. Hence, data_importantₓ=data_important₁ and data_important₁ is used as the total amount of data in the transmitted video group, data_send, i.e.:

data_send=data_important₁.

In a second case, the amount of data allowable by the available network bandwidth is moderate. The video transmitter searches for the total amount of data in the important code stream block, data_important, subjected to a constraint that data_important shall be smaller than or equal to data_request and data_important shall be close to data_request. Hence, the data_importantₓ as found is used as the total amount of data in the transmitted video group, data_send, i.e.:

data_send=data_importantₓ, where 1<=x<=64.

In a third case, the amount of data allowable by the available network bandwidth is so large that the maximum value of data_important is larger than the total amount of data in the video group requested for transmission, data_request. Hence, data_importantₓ=data_important₆₄ and data_important_{M} is used as the total amount of data in the transmitted video group, data_send, i.e.:

data_send=data_important₆₄.

Once data_send has been determined, the video transmitter determines the address information (a time dimension index, T_index, a space dimension index, L_index, a quality dimension index, Q_index, a unique index of the code stream block in a frame, layer_index) of the code stream blocks by analyzing layer_information having indices smaller than or equal to x among the layer_information associated with the code stream blocks in the video group and then selects the code stream block from the compressed video code stream.

The video transmitter transmits the code stream block to the video receiver. After the transmission of the video data has completed, the video transmitter waits for the next message containing data_request.

As such, the video transmission can be adapted to the available network bandwidth. In this way, the smoothness of the video can be guaranteed even if the network environment deteriorates, despite some degradation in video quality.

What is claimed is:

1. A method for scalable transmission of a video track, comprising:
generating a video track file;
detecting, at a video receiver, an available network bandwidth passively; and
selecting, at a video transmitter, a video code stream based on address information of code stream blocks described in the video track file and the available network bandwidth for transmission.

2. The method of claim 1, wherein the video data is transmitted in units of video groups, the available network bandwidth is detected at the video receiver by measuring a time period required for receiving one video group and a total amount of data in one video group, a total amount of data in the video group requested by the video receiver for transmission is calculated further based on a frame rate for video play,
when the currently detected available network bandwidth is not suitable for transmitting high quality video, at least one code stream block having a low importance parameter is discarded in a next video group, and
when the currently detected available network bandwidth is capable of transmitting higher quality video, at least one code stream block having a low importance parameter is added to a next video group to be transmitted.

3. The method of claim 2, wherein the transmitted video comprises at least base code stream blocks, the total amount of data in the transmitted video group is dependent on the current available network bandwidth and determines code stream blocks having which importance parameter are included in the video group, the available network bandwidth is measured based on the total amount of data in the video group and determines the total amount of data in the next video group.

4. The method of claim 1, wherein said generating of the video track file comprises:
1) reading, by an encoder, a predetermined number of frames from a video source to constitute a video group;
2) applying a scalable video encoding to generate a code stream block that can be truncated arbitrarily; and
3) calculating a distortion caused by loss of a particular code stream block.

5. The method of claim 4, wherein the video track file has a description element that is a information set, layer_information, associated with the code stream block, the information set, layer_information, comprises: a time dimension index, T_index, a space dimension index, L_index, a quality dimension index, Q_index, an index of the code stream block in a frame, layer_index, a distortion caused by loss of the code stream block, layer_distortion, an amount of data in the code stream block, layer_length, an importance parameter for the code stream block, layer_important, and a total amount of data in an important code stream block, data_important,
the distortion caused by loss of the code stream block, layer_distortion, is calculated as:
$${layer}_{—} distortion = {\sum }_{0 < i \leq g} ( {\sum }_{0 < j \leq h} ( {\sum }_{0 < k \leq w} ( {a}_{ijk} - {a}_{ijk}^{′} ) ) )$$
where g is a predetermined number of frames included in one video group, g=16;
H is a height of one frame in a DCT transform domain;
W is a width of one frame in the DCT transform domain;
aᵢⱼₖ is a coefficient at a height of j and a width of k in the i-th frame when the code stream block is retained; and
a′ᵢⱼₖ is a coefficient at a height of j and a width of k in the i-th frame when the code stream block is discarded.

6. The method of claim 5, wherein the video data in the DCT transform domain is quantized, then the quantized code stream block is entropy encoded, and the amount of data in the code stream block, layer_length, is recorded;
the importance parameter for the code stream block, layer_important, is calculated based on the distortion caused by loss of a particular code stream block, layer_distortion, and the amount of data in the code stream block, layer_length:
$${layer}_{—} {improtant}_{i} = \frac{{layer}_{—} {distortion}_{i}}{{layer}_{—} {length}_{i}}$$
where layer_distortionᵢ is the distortion caused by loss of the i-th code stream block in the video group, layer_lengthᵢ is the amount of data in the i-th code stream block;
the information sets for the code stream blocks, layer_information, are sorted based on the importance parameters for the code stream blocks, layer_important, and an index of each layer_information is identified, the total amount of data in the important code stream block, data_important, is counted in the video group, which is a sum of the amount of data in a particular code stream block and the amount of data in the code stream blocks each having a higher importance parameter than that code stream block in the video group:
$${data}_{—} {important}_{j} = {\sum }_{1 \leq k \leq j} {layer}_{—} {length}_{k}$$
where j and k denote the indices of the respective layer_information after the information sets for the code stream blocks, layer_information, have been sorted.

7. The method of claim 5, wherein the available network bandwidth is detected at the video receiver by measuring a time period required for receiving one video group and a total amount of data in one video group, a total amount of data in the video group requested for transmission, data_request, is calculated at the video receiver by rounding a product of the available network bandwidth, band_width, and a frame frequency at the video receiver, time_group:
data_request=[band_width*time_group].

8. The method of claim 5, wherein the total amount of data in the important code stream block, data_important, is determined at the video receiver based on the total amount of data in the video group requested by the video receiver for transmission, data_request:
$${data}_{—} {important}_{x} = \{ \begin{matrix}{data}_{—} {important}_{{i}_{—} first} , ( {data}_{—} request < {data}_{—} {important}_{{i}_{—} first} ) \\ {data}_{—} {important}_{i} , ( \begin{matrix}{data}_{—} {important}_{i - 1} < {data}_{—} request \leq {data}_{—} {important}_{i} , \\ {data}_{—} {important}_{0} = 0 , \\ {i}_{—} first \leq i \leq {i}_{—} last \end{matrix} ) \\ {data}_{—} {important}_{{i}_{—} last} , ( {data}_{—} request > {data}_{—} {important}_{{i}_{—} last} ) \end{matrix}$$
where x is an index of layer_information where the total amount of data in the important code stream block, data_important, is found;
i_first is an index of layer_information for the most important code stream block and here i_first=1;
i_last is an index of layer_information for the least importance code stream block and here i_last=64;
data_important₀ is a variable set to search for data_important and here data_important₀=0;
data_importantᵢ_{_}_{first} is data_important associated with the most important code stream block and here data_importantᵢ_{_}_{first}=data_important₁=layer_length₁; and
data_importantᵢ_{_{—last}} is data_important associated with the least important code stream block.

9. The method of claim 8, wherein data_importantₓ reflects the total amount of data in the transmitted video group, data_send=data_importantₓ.

10. The method of claim 9, wherein the address information of the code stream blocks is determined at the video transmitter by analyzing layer_information having indices smaller than or equal to x among the layer_information associated with the code stream blocks in the video group, so as to organize the transmission of the video code stream; the video code stream is received at the video receiver when the video transmitter transmits the code stream; the address information of each code stream block comprises a time dimension index, T_index, a space dimension index, L_index, a quality dimension index, Q_index, a unique index of the code stream block in a frame, layer_index.
